(19) United States
(12) Patent Application Publication
(10) Pub. No.: US 2015/0276091 A1
(43) Pub. Date: Oct. 1, 2015

(54) Cordlike line guide device, especially for capillary tubes or the like

(71) Applicant: igus GmbH, Koeln (DE)

(72) Inventor: Thilo-Alexander Jaeker, Sankt Augustin (DE)

(21) Appl. No.: 14/676,202

(22) Filed: Apr. 1, 2015

(30) Foreign Application Priority Data
Apr. 1, 2014 (DE) 20 2014 101 546.9

(51) Int. Cl. F16L 3/015; F16L 3/26

(52) U.S. Cl. CPC F16L 3/015; F16L 3/26

(57) ABSTRACT

A line guide device (10) for protectedly guiding at least one line, in particular a capillary tube, is produced in longitudinal portions or completely in one piece and preferably from plastic. It has a first connecting element (15) for a connecting point, a second connecting element (16) for the other connecting point and a receiving means (35) for the at least one line.

According to the invention the line guide device has a cross-sectional profile (30) with a first region (31) forming a carrier leg (33) for carrying a weight load, and a second region (32) forming a widened portion (34) relative to the first region. The line guide device (10) further has at least one first pre-curved arc portion (11, 12) which has a predetermined curvature about a curvature axis (A), and at least one twistable linear portion (14) adjoining same.

The use of the line guide device for protecting a line with capillary tube and the corresponding arrangement are also described.

### TECHNICAL FIELD

The invention generally concerns a line guide device for protectedly guiding at least one line, in particular a capillary tube, between a fixed and a moveable connecting point.

### STATE OF THE ART

A very widespread example of a line guide device is the so-called energy guide chain. That comprises individual link members which are generally composed of individual parts. Patents DE3531066C2, EP0803032B1 and EP1381792B1 to the present applicant describe such energy guide chains with link members comprising two, four or six individual parts. Such chains have greatly proven their worth. They are robust and reliable but relatively expensive and complicated to manufacture.

The present invention does not concern a chain comprising individual link members but a line guide device as set forth in the classifying portion of claim 1. In that line guide device which is rather of a cordlike configuration at least one longitudinal portion, the entire line guide device, is made from one piece.

Line guide devices which are partially or completely produced in one piece are also already known, for example from patent application DE10200500453A1 or patent EP1138555B1. Such line guide devices which can be substantially produced in one piece are particularly suited for uses involving large numbers of items and a relatively short guide length, for example for the supply of motor vehicle seats.

A cordlike line guide, that is to say a line guide which is produced completely or portion-wise over its length in one piece, is previously known from WO 2005/040659 A1. That line guide device for protectedly guiding at least one line like for example a cable, a hose or the like, is considered herein as the most relevant state of the art as it is designed in particular for shorter lengths and smaller line diameters. That line guide device extends between a stationary connecting point and a connecting point which is moveable relative thereto and in that case is produced at least portion-wise in its longitudinal portions or completely in one piece in the form of a plastic portion. It includes a first and a second connecting end for each connecting point and a receiving means for the at least one line. In that case individual members are shaped in one piece in the form of substantially rigid U-shaped profiles, wherein a cover element is shaped on a side wall and can be transferred into a position of closing the member and a position of opening the receiving means. Because the members of the one-piece cord are produced in the form of substantially rigid U-shaped profiles that line guide device enjoys high stability even with comparatively small members.

A cordlike line guide in accordance with WO 2005/040659 A1 can admittedly be produced less expensively than typical energy guide chains. However, inter alia due to the principle of individual members with a U-shaped profile, the joint connection thereof with each other comprising a film hinge, and also by virtue of the cover elements which can be pivoted open, they are still of a really complex structure.

### OBJECT

An object of the present invention is accordingly to provide a line guide device which is of a particularly simple structure, in particular being of very low inherent weight, and/or which requires very little structural space. The aim of the invention is in particular also to provide a line guide device suitable for the protection of a capillary tube.

### GENERAL DESCRIPTION OF THE INVENTION

According to the invention that object is attained in that the line guide device has a cross-sectional profile of comparatively simple configuration, with a first region forming a carrier leg for carrying a weight load, and a second region forming a widened portion in relation to the first region. According to the invention the line guide device further has at least one first pre-curved arc portion having a predetermined curvature about a curvature axis, and at least one straight linear portion adjoining same, which is twistable in itself or about its own longitudinal axis, in particular upon excessive compressive upsetting of the arc portion with respect to the curvature axis. In that respect excessive means in particular compressive upsetting of the arc portion so that the radius would fall below the permissible minimum radius for protecting the guided line or lines in relation to kinking or buckling.

The invention thus deviates from the basic principle of typical energy guide chains in which abutments which cooperate in relatively moveable relationship ensure a minimum curvature radius in a deflection arc. In the case of the line guide device proposed here such abutments are basically not required. According to the invention, in the range of appropriate loadings, when a certain flexural stressing of the arc portion is exceeded, twisting or torsion of the adjoining linear portion occurs. That torsion in turn permits or leads to a rearing-up or veering-off of the arc portion in a direction approximately parallel to its curvature axis so that that arc portion can maintain a certain minimum radius without being further compressed.

The predetermined curvature of the arc portion, that is to say the pre-curvature of the arc portion in the unloaded condition, and the material thereof, are so selected that the reaction force in the linear portion leads to twisting or to the torsion effect according to the invention, in particular in the linear portion. Accordingly the profile cross-section is also selected in conjunction with material and pre-curvature. In particular for that reason there is provided the at least one thickening portion which, upon curvature, leads to a transition from maximum tensile loading at the outside to maximum compressive loading at the inside on the arc portion.

Without wishing to tie down the invention to a given theory it is assumed that the torsion effect produced thereby, which avoids the arc portions being excessively bent together or which causes the arc portion to veer off along the curvature axis is to be attributed to a force distribution, similarly to the force distribution which leads to a failure mode, which is known from the field of steel beam statics as so-called “flexural twist buckling” (the English term is “lateral torsional buckling”). In the range of proper loadings however the invention reliably prevents buckling and makes use of the otherwise unwanted torsion effect rather for absorbing an excessive stress.

By virtue of making use of that effect in principle particular abutments for providing a lower limitation in respect of the deflection radius are in principle unnecessary, which considerably simplifies the structure of the line guide device and reduces the inherent weight and the required structural space thereof.

In a preferred configuration there is provided a second pre-curved arc portion which also has a predetermined curvature about a curvature axis, wherein the curvature directions of the first and second arc portions are in opposite relationship. In that case the at least one linear portion is arranged between the arc portions and is of a configuration similar to a S-curve configuration. The torsion effect can thus be enhanced and the flexural loading in the individual arc portions can be approximately halved by virtue of the relative movement of the connecting elements. For that purpose the predetermined curvature in both arc portions is preferably of equal magnitude, that is to say selected with an identical curvature radius.

For more extensive structural simplification it is advantageous if the second region forms the receiving means for the line or lines, particularly preferably of a configuration in the manner of a pipe snap-engagement clip. In that case or also with a different kind of fixing, it is desirable to provide an opening for introducing the at least one line, which opening is preferably in opposite relationship to the carrier leg. In principle the receiving means could be completely peripherally closed, but in that case the line would have to be passed through or threaded in from the ends, which is complicated and makes later replacement considerably more difficult.

If the second region of the profile cross-section, besides the widened portion for the purposes of force distribution, also provides the receiving means for the line or lines, it is advantageous if the widened portion of the second region forms a one-piece transition between the first region and the receiving means. Preferably in that case the widened portion is of a cross-sectional width of a larger dimension than the maximum cross-sectional width of the first region or the carrier leg. The cross-sectional width of the first region or the carrier leg, except for inessential parts like for example a possible rounded-off configuration at an end region, can desirably be approximately constant, but however may vary within the second region for example for saving on material.

In a preferred configuration the line guide device is so arranged that the curvature axis of the at least one arc portion extends substantially parallel to the main extent of the carrier leg, in particular substantially vertically.

In a preferred configuration the line guide device is of a T-like or Y-like cross-sectional profile. In that case the flange or web, that is to say the region of the cross-sectional profile which is approximately perpendicular to the carrier leg, can preferably form the receiving means for precisely one line. In that case the flange can for example be of a C-like shape with an upwardly directed opening.

To minimize the transmission of torsional loading between the line guide device and the line guided therein it is advantageous if the receiving means is of a circular cross-section and receives the line with a radial play in relation to torsion so that the line is free in the receiving means to turn relative thereto or not or only partially to turn therewith.

The proposed line guide device is particularly suitable for guiding a single line and/or a line of relatively small diameter. Accordingly the diameter of the receiving means is preferably in particular markedly less than 20 mm, and is preferably less than 10 mm.

A profile cross-section which has proved its worth in practice is one in which the maximum width of the first region is less than the receiving means diameter. The maximum width of the first region is preferably of a magnitude in the range of between 10% and 60% of the receiving means diameter. That makes it possible to achieve a particularly simple structure which saves on material for the cordlike line guide device.

In an advantageous embodiment each arc portion in the non-loaded condition is larger with an arc size than in the case of a 180° arc, that is to say an arc size >180°, in particular ≧200°. Thus additional flexibility can be achieved inter alia in regard to spreading open the arc portions.

In a pragmatic embodiment, in particular for analysis devices, it is provided that the curvature axis of each arc portion extends approximately vertically and the relatively moveable connecting point is displaceable in an approximately horizontal plane relative to the fixed connecting point. In contrast it is also in accordance with the invention if the relatively moveable connecting point is additionally or alternatively vertically displaceable and/or the curvature axis of each arc portion extends approximately horizontally.

In order to provide free space for the at least one arc portion to rear up or veer off a preferred embodiment provides adjoining each connecting element a respective pre-curved bridge portion, wherein the bridge portions are arranged with a curvature axis perpendicularly to the main extent of the carrier leg. The curvature axis of the bridge portions can be disposed in conformity with the structure described hereinbefore, in particular approximately horizontally.

The line guide device can be produced completely in one piece, for example in the form of a continuous plastic portion using an injection molding process, or it can be composed in a modular and use-specific fashion in accordance with the building brick principle. In a modular structure it is advantageous if the line guide device is composed of individual, one-piece arc portions and linear portions which are connected by means of connecting portions in force-locking and/or positively locking relationship, in particular in torsion-transmitting relationship, to afford a continuous line guide device.

The material, in least in the linear portions, is preferably selected to be sufficiently torsionally elastic that buckling, in particular so-called lateral torsional buckling, is to be avoided even when the maximum nominal loading is slightly exceeded. The maximum nominal loading can be achieved for example when the relatively moveable connecting point is moved to the minimum spacing relative to the stationary connecting point.

The proposed line guide device is suitable in particular for protecting precisely one line with a capillary tube, in particular in an analysis device like for example an automatic pipetting device or an automatic dosage device in medical or chemical analysis technology, or for example for protecting precisely one glass fiber line, in particular in a machine with data processing. Accordingly the invention also concerns precisely one arrangement of the line guide device according to the invention and precisely one line with capillary tube or precisely one glass fiber line or light wave guide which is guided and protected by the line guide device and for that purpose accommodated therein.

### BRIEF DESCRIPTION OF THE FIGURES

Further details, advantages and features of the invention will be apparent from the following part of the description in which two embodiments by way of example are described in greater detail with reference to the accompanying drawings in which:

FIG. 1 shows a perspective view of a first embodiment of a cordlike line guide device which is produced in one piece throughout,

FIG. 2 shows a perspective view of a second embodiment of a cordlike line guide device which is produced portion-wise in one piece,

FIG. 3 shows a cross-sectional profile along section line III-III in FIG. 1 or FIG. 2,

FIGS. 4-7 show individual parts produced in one piece of a modular system for the production of a line guide device as shown in FIG. 2 as a perspective view (FIGS. 4-5 and FIG. 7) and as a cross-section (FIG. 6),

FIGS. 8A-8D show a prototype as shown in FIG. 1 as snapshots of a series of movements for illustrating the torsion effect according to the invention in a linear portion in the event of the excessive compressive upsetting of the curve portions as a side view on black/white-inverted photographs, and

FIGS. 9A-9D show plan views of the snapshots of the series of movements corresponding to FIGS. 8A-8D.

### DESCRIPTION OF THE EMBODIMENTS BY WAY OF EXAMPLE WITH REFERENCE TO THE FIGURES

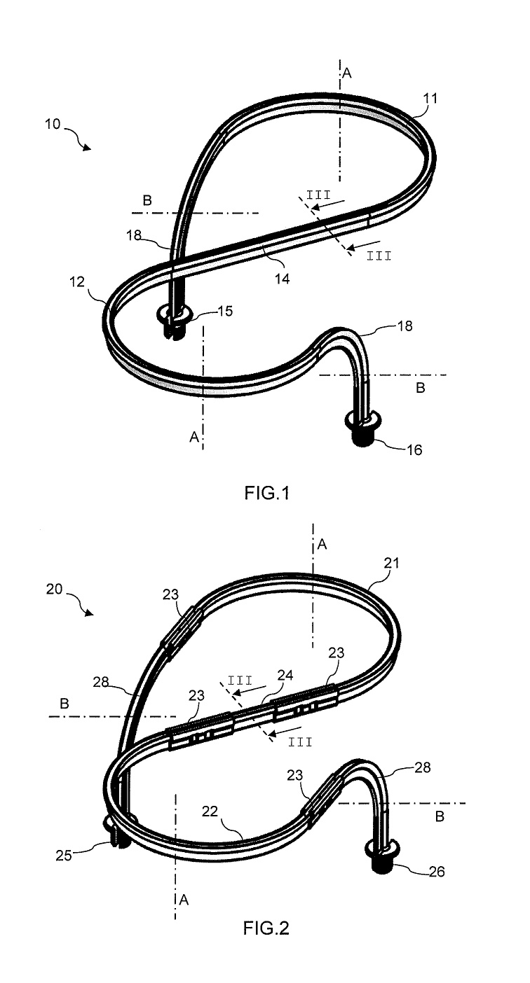

In FIG. 1 a line guide device produced completely in one piece in the form of a plastic part is denoted generally by 10. The line guide device includes as its main components a first and a second arc portion 11, 12 which are connected with an opposite arc configuration by a linear portion 14. A respective bridge portion 18 is formed at the other end region of each arc portion 11, 12. Formed on each bridge portion 18 is a connecting element 15, 16 in one piece therewith, for example with a male thread for screwing to a stationary connecting point and a connecting point moveable relative thereto of an automatic pipetting device (not shown). Also not shown in greater detail is a capillary line comprising a protective casing and a capillary tube which is disposed therein and which is protected by the line guide device 10.

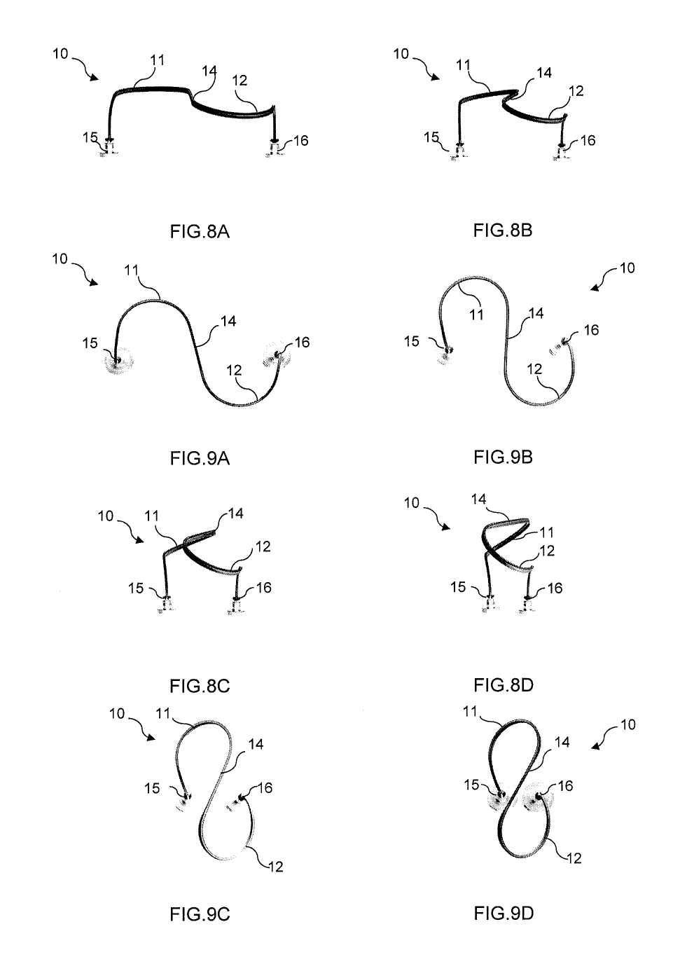

FIG. 1 shows the line guide device 10 in the non-loaded condition, that is to say the one connecting element 15 or 16 is disposed on approximately half the displacement path relative to the other connecting element 16 and 15 respectively. Each arc portion 11, 12 is pre-curved about a vertical curvature axis A. The linear portion 14 is straight and is twistable in itself, as described hereinafter with reference to FIGS. 8A-8D and FIGS. 9A-9D respectively. The configuration of the line guide device 10 is an S-curved configuration. The bridge portions 18 which are curved about horizontal axes B lift that S-curved configuration to a plane which is markedly above the plane of movement of the connecting elements 15, 16 or connecting points.

The line guide device 20 in the second embodiment in FIG. 2 is of the same configuration and is constructed on the same principle as the line guide device 10 in FIG. 1. The sole substantial difference is that the line guide device 10 is not completely in one piece but is composed of a relatively small number of individual, one-piece plastic portions which form longitudinal portions of the line guide device 20. In this case, a respective one of the two arc portions 21, 22 (FIG. 4) is fixed to a respective one of two identically produced bridge portions 28 (see FIG. 5) at the end opposite to the connecting element 25, 26 formed thereon, by way of straight connecting portions 23 (FIGS. 6-7). The two arc portions 21, 22 in turn are connected at their other end to the central linear portion 24 by way of further connecting portions 23 in tension- and torsion-resistant fashion. Naturally this modular system comprising arc portions 21, 22, linear portions 24, bridge portions 28 and connecting portions 23 can also be implemented to constitute a different configuration, for example a double-S-curve configuration.

FIG. 5 shows a pre-curved arc portion 21 which is produced as a one-piece plastic part. The arc portion 21 has an arc size of approximately 210-230° so that, even with a larger curvature radius in respect of the arc portions 21, 22, the two connecting elements 26, 28 are quite close together in the non-loaded condition (or the linear portion 24 extends like a hypotenuse).

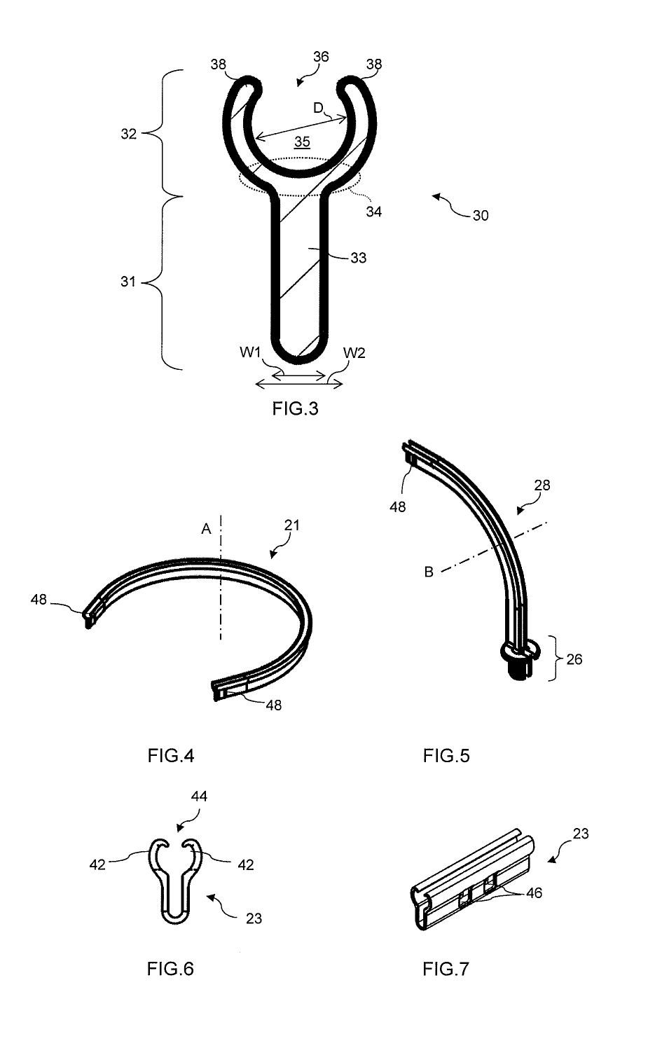

FIGS. 6-7 also show in greater detail the structure of the connecting portion 23 for the modular system. Each connecting portion 23 has an inside contour which is adapted in positively locking relationship to the outside contour (FIG. 3) of the individual shaped portions 21, 22, 24. The connecting portion 23 is gripped on to the individual parts to be connected by way of the opening 44. The positively locking connection and also the holding claws 42 provide that the torsion or torque is transmitted in particular from the respective arc portion 21, 22 to the adjoining linear portion 24. For tensile force transmission, provided on the connecting portions 23 on both sides and centered in relation to the center are two latching holes 46. The latching holes latch with two oppositely disposed latching noses 48 at the end regions of the arc portions 21, 22, linear portions 24 (not shown in FIGS. 4-7) or bridge portions 28.

FIG. 3 shows a preferred cross-sectional profile for the line guide devices 10 and 20 respectively. The cross-sectional profile 30 has a first lower region 31 forming a carrier leg 33 for carrying a weight load, that is to say it extends with its main extent approximately vertically (in the non-loaded condition). Adjoining it above the first region 31 is a second region 32 which forms a cross-sectional widening enlargement 34, emphasized in broken line in FIG. 3. The cross-sectional enlargement 34 is of a larger cross-sectional width W2 than the cross-sectional width W1 of the first region 31. The cross-sectional widths W1, W2 are respectively measured from outside to outside of the cross-sectional profile 30. The second region 32 comprises the cross-sectional enlargement 34 and snap-engagement bars 38 with rounded ends, that adjoin the enlargement 34 and are curved to converge upwardly. The snap-engagement bars 38 form a kind of pipe snap-engagement clip with an opening 36 for insertion of the capillary line at the upper end which is vertically opposite the carrier leg 33. Thus the cross-sectional enlargement 34 also forms a one-piece transition between the first region 31 and the receiving means 35. The carrier leg 33 is vertical insofar as in particular the linear portion 14 or 24 is not twisted in itself.

Overall therefore FIG. 3 shows an approximately T-like or Y-like cross-sectional profile 30, wherein the second region 32 forms on the one hand the receiving means 35 for precisely one line and with the cross-sectional enlargement 34 on the other hand at the same time forms a kind of flange or web for the carrier leg 33. The receiving means 35 is of a round cross-section and is intended to receive the line (not shown) with radial play. Typical inside diameters for smaller lines are less than 20 mm, in part less than 10 mm. In the preferred embodiment of FIG. 3 the maximum width W1 of the first region 31 is markedly smaller than the receiving means diameter D, with W1 being approximately equal to 0.6×D.

FIGS. 8A-8D show a series of movements by reference to a prototype of a line guide device 10 shown in FIG. 1 which is completely in one piece. Starting from the non-loaded condition shown in FIG. 1 (FIGS. 8A/9A) the one connecting element 16 is moved towards the other connecting element 15. Thus firstly the arc portions 11, 12 are slightly upset towards each other, that is to say curved more greatly (FIGS. 8B/9B). In that respect the linear portion 14 disposed in the center between the arc portions 11, 12 already begins to deflect slightly upwardly and in that case is also already slightly twisted in itself. When the connecting element 16 moves closer to the other connecting element 15 then the ends of the arc portions 11, 12, that are remote from the connecting elements 15, 16, rise further upwardly, while retaining a predetermined minimum curvature radius in respect of the line guide device 10 or the arc portions 11, 12, in which case the linear portion 14 is correspondingly more greatly twisted (FIGS. 8C/9C). In the end position shown in FIG. 8D and FIG. 9D the connecting elements 15, 16 almost adjoin each other and the deformation between the curvature position of FIG. 8B is substantially exclusively absorbed by the torsion of the linear portion 14 about its own axis.

### LIST OF REFERENCES

FIG. 1
10 line guide device
11 first arc portion
12 second arc portion
14 linear portion
15, 16 connecting elements
18 bridge portion
A, B curvature axes

FIG. 2
20 line guide device
21 first arc portion
22 second arc portion
23 connecting portion
24 linear portion
25, 26 connecting elements
28 bridge portion
A, B curvature axes

FIG. 3
30 cross-sectional profile (along section lines III-III0
31 first region
32 second region
33 carrier leg
34 cross-sectional widening enlargement
35 receiving means
36 opening
38 snap-engagement bars
D receiving means diameter
W1, W2 cross-sectional width

FIGS. 4-7
21 arc portion
23 connecting portion
28 bridge portion
42 holding claws
44 opening
46 latching holes
48 latching noses

FIGS. 8A-8D and FIGS. 9A-9D
10 line guide device
11, 12 arc portions
14 linear portion
15, 16 connecting elements

1. A line guide device for protectedly guiding at least one line like for example a cable, a hose or the like, in particular a capillary tube, between a stationary connecting point and a connecting point moveable relative thereto, wherein the line guide device is produced in longitudinal portions or completely in one piece, from plastic, and includes a first connecting element for the one connecting point, a second connecting element for the other connecting point and a receiving means for the at least one line, characterised in that the line guide device has a cross-sectional profile with a first region forming a carrier leg for carrying a weight load and a second region forming a widened portion with respect to the first region, and includes at least one first pre-curved arc portion which has a predetermined curvature about a curvature axis, and at least one linear portion which adjoins same and which is twistable.

2. A line guide device as set forth in claim 1 characterised in that it has a second pre-curved arc portion which has a predetermined curvature about a curvature axis, wherein the curvature directions of the first and second arc portions are in opposite relationship and the at least one linear portion is arranged between the arc portions, wherein the line guide device has a configuration similar to an S-curve configuration.

3. A line guide device as set forth in claim 1 characterised in that the second region forms the receiving means in the manner of a pipe snap-engagement clip and/or with an opening for the insertion of the at least one line, which is in opposite relationship to the carrier leg.

4. A line guide device as set forth in claim 3 characterised in that the widened portion of the second region forms a one-piece transition between the first region and the receiving means and is of a cross-sectional width greater than the maximum cross-sectional width of the first region.

5. A line guide device as set forth in claim 1 characterised in that the curvature axis of the at least one arcuate portion extends substantially parallel to the main extent of the carrier leg.

6. A line guide device as set forth in claim 1 characterised in that the line guide device is of a T-like or Y-like cross-sectional profile, wherein the flange- or web-like second region forms the receiving means for precisely one line.

7. A line guide device as set forth in claim 1 characterised in that the receiving means is of a circular cross-section and receives the line with radial play, the diameter of the receiving means being less than 20 mm.

8. A line guide device as set forth in claim 7, characterised in that the maximum width of the first region of the profile cross-section is smaller than the receiving means diameter.

9. A line guide device as set forth in claim 1 characterised in that the arc portion is formed with an arc size >180°.

10. A line guide device as set forth in claim 1 characterised in that the curvature axis of each arc portion extends approximately vertically and the relatively moveable connecting point is displaceable in a substantially horizontal plane with respect to the fixed connecting point.

11. A line guide device as set forth in claim 1 characterised in that provided adjoining each connecting element is a respective pre-curved bridge portion, with a curvature axis perpendicular to the main extent of the carrier leg.

12. A line guide device as set forth in claim 1 characterised in that it is composed of individual arc portions and linear portions which are produced in one piece and which are connected together by means of connecting portions in force-locking and/or positively locking relationship.

13. A line guide device as set forth in claim 1 characterised in that the material of the linear portions is sufficiently torsionally elastic to avoid buckling.

14. Use of a line guide device as set forth in claim 1 for the protection of precisely one line with capillary tube.

15. An arrangement including a line guide device as set forth in claim 1 and a line with capillary tube or precisely one light wave guide, which is received in the line guide device.
